(19) United States
(12) Patent Application Publication
(10) Pub. No.: US 2025/0342510 A1
(43) Pub. Date: Nov. 6, 2025

(54) PROJECTION BASED TELECOMMUNICATIONS MANAGEMENT ORDERING SYSTEM

(71) Applicant: Telefonaktiebolaget LM Ericsson (publ), Stockholm (SE)

(72) Inventor: Katerina MINKOVSKI, Ontario (CA)

(73) Assignee: Telefonaktiebolaget LM Ericsson (publ), Stockholm (SE)

(21) Appl. No.: 18/871,805

(22) PCT Filed: Jul. 6, 2022
(86) PCT No.: PCT/IB2022/056258

§ 371 Date: Dec. 4, 2024

(51) Int. Cl. G06Q 30/0601; G06Q 30/0201

(52) U.S. Cl. CPC G06Q 30/0609; G06Q 30/02016

(57) ABSTRACT

A management node for managing a plurality of orders is disclosed. The management node comprises processing circuitry configured to: determine a first projection of a current install base based on an execution date of a first order of the plurality of orders, the first order including at least one change to the current install base, and the plurality of orders being configured to be executed in a sequence; determine whether the first order is valid based on the determined first projection of the current install base; and one of reject and queue the first order for execution on the execution date of the first order based on the determination of whether the first order is valid.

### TECHNICAL FIELD

The present disclosure relates to telecommunications management ordering system, and in particular, to a projection based telecommunication management ordering system.

### BACKGROUND

In telecom ordering management system, a typical customer order is placed to add new products/services or modify existing products/services. With exception of a customer on-boarding scenario where an order is placed for a new customer with no previous installed products/services, other customer orders may rely on already provisioned and installed products/services that are referred to as a customer's “install base.” A typical install base may contain customer's contract(s), active and deactivated entities such as subscriptions, devices, voice and data services, eligible discounts, and so on. When a new order is initiated, an existing install base is loaded to help ensure the new order's changes can be applied and are compatible with the customer's most recent install base. For instance, the customer may not be able to place an order to add an extra 5 Gb of data usage if their install base does not include any data service.

It may be preferred to have the most recent customer's install base at order creation and order fulfillment, so the order changes are applied to the real time install base. Otherwise, if there is no access to a customer's install base or the install base is outdated, the new order may trigger invalid set of products/services leading to a potentially inconsistent configuration of services and invalid service charges.

There are scenarios when the install base may change between order's creation and order's fulfillment time. It implies the order executes with an outdated install base or is out of sync with the most recent persisted install base, hence rendering the order changes inconsistent with the customer's actual install base.

Two scenarios which may create issues in existing system are described below.

Future dated order: When an order executes immediately after creation, it is relatively safe to assume the order's install base and the actual install base in the persistence layer are in sync. However, if an order created today is set to execute in the future, there is no guarantee the customer's install base remains unchanged until order's execution date. For instance, between order creation and execution a service expires based on its lifecycle dates or installed base is modified externally via other channels (e.g., service suspended due to dunning).

Stack of orders: Having order rely solely on the install base state at order's creation time becomes more challenging when there is a need to place multiple consecutive orders. As an example, a customer wants to purchase a subscription today while there is a promotion, yet they don't need to use it until they move to college one month later, hence they request to buy a subscription, then suspend it immediately and resume it after one month. The customer representative immediately places an order for a new subscription, yet order completion may take hours/days because it requires special approval from the manager. While the subscription is not provisioned to the install base there is no possibility to place a second order to suspend the product and, similarly, to place the third order to resume it in the future. If customer representative creates a second order right away, the order loads the most recent customer's install base without the subscription and therefore without the product to apply the suspension. The customer representative may need to wait until the subscription is successfully provisioned and published to the install base, then create a suspend order. By the time suspend order can be created, the subscription is already active and may incur charges. Again, to create a “resume” order, the customer representative may need to wait until suspension order completes in a few hours/days. It is a complicated and expensive process for customer service to coordinate order placement based on order completion, one by one. The scenario can be further complicated if there is a need to create an order scheduled before an existing future dated order. For instance, the same customer calls a couple weeks later and requests to alter subscription's data allowance before the subscription is resumed. The new order executes immediately provisioning new data allowance value. However, when the resume order runs few weeks later it overrides the new allowance configuration with the original value resulting in unexpected subscription configuration.

Hence, existing order management systems are not without issues.

### SUMMARY

Some embodiments advantageously provide methods, systems, and apparatuses for telecommunications order management.

When an order is set to execute in the future, it may not be created assuming the most recent install base but a projection of the install base anticipated at a time of an order execution. The projection is calculated considering changes from one or more (e.g., all) other of the customer's non-completed orders expected to execute before this order and, in some embodiments, based on an estimated lifecycle changes of existing products and services.

One or more embodiments described herein relate to implementing a customer's future orders as a stack of orders sequenced by the execution date, where a first order is based on the actual install base while each consecutive order's install base is a projection of install base resulting from the previous order in the queue. If every order executes strictly in the sequence of its position in the queue and each order starts when the previous order in the queue completes, then the order's projection of the install base is a very close approximation of the real time install base. This solution supports further scenarios where a new order can be injected anywhere in the established order queue. In this case, the injected order is positioned in the queue based on its requested start date, gets created from projection of preceding orders and triggers re-projection of the subsequent orders.

The order stack ensures a future dated order is created based on the best possible approximation of the install base expected at order execution time. It also supports creation of multiple future dated orders, where each order relies on changes from previous non-executed orders and applies actions considering these previous non-completed changes although they are not yet available in real time.

In one or more embodiments, an order is not be based on the install base state at order creation. Instead, it should rely on a projection of the install base at the order's scheduled execution time. The projection is calculated based on one or more of the following factors:
1. Changes from one or more (e.g., all) customer's orders that are scheduled to be executed before the current order.
2. Existing products/services lifecycle transitions such as scheduled activation or expiry.

The customer's future dated orders may be viewed as a stack of orders, where each order calculates its install base from a previous order.

When a new order is created and scheduled to run after non-completed customer's order(s), then it should be based on projection from these previous orders.

When a new order is created and is scheduled to run before other future-dated orders then the change from the current order is propagated into these subsequent orders' install base. In other words, the subsequent orders re-calculate the install base projection and re-apply order changes to be valid or to verify the validity of one or more orders/changes. Typically, only non-completed orders are considered because completed orders already provisioned changes in the real time install base.

One or more embodiments described herein works if stack orders run consecutively, each waiting for the previous order to complete successfully. When these conditions are enforced, programmatically or otherwise, then it is safe to state orders run with the best approximation of the customer's install base.

According to one aspect of the present disclosure, a management node for managing a plurality of orders is provided. The management node includes processing circuitry that is configured to determine a first projection of a current install base based on an execution date of a first order of the plurality of orders, where the first order including at least one change to the current install base. The plurality of orders are configured to be executed in a sequence. The processing circuitry is also configured to determine whether the first order is valid based on the determined first projection of the current install base; and then reject or queue the first order for execution on the execution date of the first order based on the determination of whether the first order is valid.

According to some embodiments of this aspect, the processing circuitry is further configured to determine a second projection of the current install base based on an execution date of a second order of the plurality of orders. The second order includes at least one change to the current install base. According to some embodiments of this aspect, the second order precedes the first order in the sequence, and the determination of whether the first order is valid is further based on the determined second projection of the current install base. According to some embodiments of this aspect, the second order follows the first order in the sequence, and the determination of whether the second order is valid is further based on the determined second projection of the first install base.

According to some embodiments of this aspect, the sequence is chronological based on execution date of each of the plurality of orders. According to some embodiments of this aspect, the processing circuitry is further configured to determine a projection for each of the plurality of orders, each of the projections for each of the plurality of orders including at least one change to the current install base. According to some embodiments of this aspect, determining whether the first order is valid is further based on the determined projections of each of the plurality of orders. According to some embodiments of this aspect, determining whether the first order is valid is further based on an evaluation of each of the determined projections of each of the plurality of orders, the evaluation being based on the sequence of execution of the plurality of orders.

According to another aspect of the present disclosure, a method implemented by a management node for managing a plurality of orders is provided. A first projection of a current install base is determined based on an execution date of a first order of the plurality of orders where the first order includes at least one change to the current install base, and the plurality of orders are configured to be executed in a sequence. A determination is performed as to whether the first order is valid based on the determined first projection of the current install base, and the first order for execution on the execution date of the first order is one of rejected and queued based on the determination of whether the first order is valid.

According to some embodiments of this aspect, a second projection of the current install base is determined based on an execution date of a second order of the plurality of orders, the second order includes at least one change to the current install base.

According to some embodiments of this aspect, the second order precedes the first order in the sequence, and the determination of whether the first order is valid is further based on the determined second projection of the current install base. According to some embodiments of this aspect, the second order follows the first order in the sequence, and the determination of whether the second order is valid is further based on the determined first projection of the current install base. According to some embodiments of this aspect, the sequence is chronological based on execution date of each of the plurality of orders. According to some embodiments of this aspect, a projection for each of the plurality of orders is determined where each of the projections for each of the plurality of orders includes at least one change to the current install base.

According to some embodiments of this aspect, the determination whether the first order is valid is further based on the determined projections of each of the plurality of orders. According to some embodiments of this aspect, the determination whether the first order is valid is further based on an evaluation of each of the determined projections of each of the plurality of orders, the evaluation being based on the sequence of execution of the plurality of orders.

According to another aspect of the present disclosure, a computer readable medium storing an executable program including instructions configured to cause processing circuitry to determine a first projection of a current install base based on an execution date of a first order of the plurality of orders where the determined first projection of the current install base includes at least one change to the current install base and the plurality of orders are configured to be executed in a sequence, determine whether the first order is valid based on the determined first projection of the current install base, and one of reject and queue the first order for execution on the execution date of the first order based on the determination of whether the first order is valid.

According to some embodiments of this aspect, the instructions are further configured to cause the processing circuitry to determine a second projection of the current install base based on an execution date of a second order of the plurality of orders, the second order includes at least one change to the current install base. According to some embodiments of this aspect, the second order precedes the first order in the sequence, and the determination of whether the first order is valid is further based on the determined second projection of the current install base. According to some embodiments of this aspect, the second order follows the first order in the sequence, and the determination of whether the second order is valid is further based on the determined first projection of the current install base.

One or more advantages of one or more embodiments include: enabling Future Dated Orders to run based on install base projection, enabling telecom operators to place a series of consecutive orders and run them with the best projection of the install base, and minimizing inconsistent customer's install base, invalid orders, and unexpected service configuration.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example system according to some embodiments of the present disclosure;

FIG. 2 is a block diagram of several entities according to some embodiments of the present disclosure;

FIG. 3 is a flowchart of an example process in a management node according to some embodiments of the present disclosure;

FIG. 4 is a schematic diagram of an example network architecture according to some embodiments of the present disclosure;

FIG. 5 is a flowchart of an example process according to some embodiments of the present disclosure;

FIG. 6 is a timeline diagram of execution dates of orders according to some embodiments of the present disclosure;

FIG. 7 is a timeline diagram of execution dates of orders according to some embodiments of the present disclosure;

FIG. 8 is a timeline diagram of a customer's install base according to some embodiments of the present disclosure; and

FIG. 9 is a timeline diagram of a customer's install base according to some embodiments of the present disclosure.

### DETAILED DESCRIPTION

As discussed above, existing telecommunication order management systems may not operate correctly during various scenarios because an order is usually based on an install base snapshot at order creation time, yet when an order executes the install base is already changed by other orders or by other channels or by natural lifecycle transitions within the products/services.

One or more embodiments of the present disclosure solves at least one problem with exiting systems by determining and using, for example, a projection of the install base. For example, when an order is set to execute in the future it is not created assuming the most recent install base but a projection of the install base anticipated at a time of an order execution. The projection is calculated considering changes from all other customer's non-completed orders expected to execute before this order as well as estimated lifecycle changes of existing products and services.

Before describing in detail exemplary embodiments, it is noted that the embodiments reside primarily in combinations of apparatus components and processing steps related to a telecommunications ordering management system. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Note further, that functions described herein as being performed by a device or a management node may be distributed over a plurality of devices and/or management nodes. In other words, it is contemplated that the functions of the management node and device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

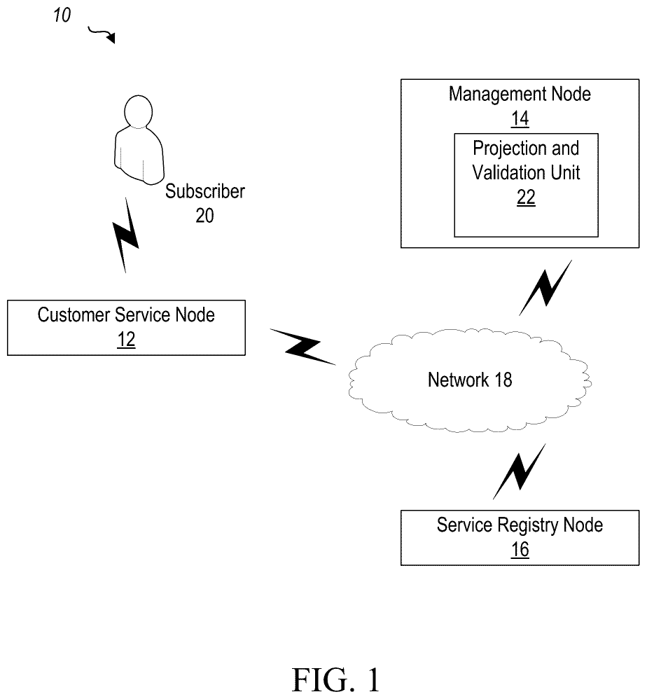

Referring to the drawing figures, in which like elements are referred to by like reference numerals, there is shown in FIG. 1 a schematic diagram of a communication system 10. The system 10 includes a customer service node 12, management node 14, and service registry node 16 that may be in communication with each other and/or other nodes in system 10 via network 18. The connection to and/or from network 18 may be a wired or wireless connection.

In particular, the customer service node 12 is configured to perform one or more functions described herein. For example, the customer service node 12 is configured to interface with a customer service representative to facilitate creation of orders based on, for example, a request from a subscriber 20. The management node 14 is configured to perform one or more functions described herein. For example, the management node 14 is configured to manage the orders as described herein. A management node 14 is configured to include a projection and validation unit 22, which is configured to perform one or more management node 14 functions described herein such as determine a projection of an order and determine based on that projection whether the order is valid, as described herein. The service registry node 16 is configured to perform one or more functions as described herein. For example, service registry node 16 may store a user's/subscriber's install base.

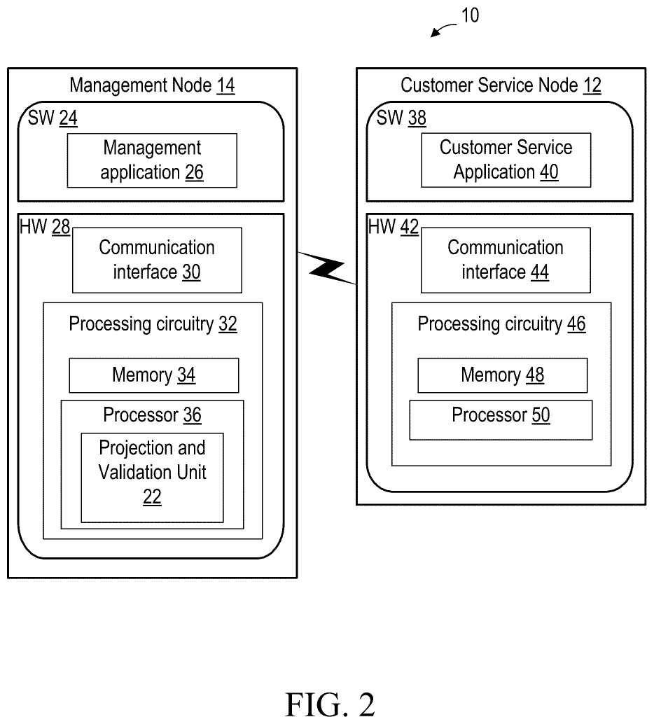

An example implementation, in accordance with an embodiment, of the management node 14 and customer service node 12 discussed in the preceding paragraphs will now be described with reference to FIG. 2.

The system 10 includes a management node 14 provided in a system 10 and including hardware 28 enabling it to perform one or more functions described herein. The hardware 28 may include a communication interface 30 for communicating with one or more nodes/devices in system 10 such as with customer service node 12.

In the embodiment shown, the hardware 28 of the management node 14 further includes processing circuitry 32. The processing circuitry 32 may include a processor 36 and a memory 34 (e.g., computer readable medium, non-transitory computer readable medium, etc.). In particular, in addition to or instead of a processor, such as a central processing unit, and memory, the processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 36 may be configured to access (e.g., write to and/or read from) the memory 34, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the management node 14 further has software 24 stored internally in, for example, memory 34, or stored in external memory (e.g., database, storage array, network storage device, etc.) accessible by the management node 14 via an external connection. The software 24 may include a management application 26 and be executable by the processing circuitry 32. The processing circuitry 32 may be configured to control any of the methods and/or processes described herein and/or to cause such methods, and/or processes to be performed, e.g., by management node 14. Processor 36 corresponds to one or more processors 36 for performing management node 14 functions described herein. The memory 34 is configured to store data, programmatic software code and/or other information described herein. In some embodiments, the software 24 may include instructions that, when executed by the processor 36 and/or processing circuitry 32, causes the processor 36 and/or processing circuitry 32 to perform the processes described herein with respect to management node 14. For example, processing circuitry 32 of the management node 14 may include a projection and validation unit 22 which is configured to perform one or more functions described herein such as with respect to, for example, projecting and validating orders.

With respect to customer service node 12, in the embodiment shown, the hardware 42 of the customer service node 12 further includes processing circuitry 46. The processing circuitry 46 may include a processor 50 and a memory 48 (e.g., computer readable medium, non-transitory computer readable medium, etc.). In particular, in addition to or instead of a processor, such as a central processing unit, and memory, the processing circuitry 46 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 50 may be configured to access (e.g., write to and/or read from) the memory 48, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

The customer service node 12 further has software 38 stored internally in, for example, memory 48, or stored in external memory (e.g., database, storage array, network storage device, etc.) accessible by the customer service node 12 via an external connection. The software 38 may include a customer service application 40 and be executable by the processing circuitry 46. The processing circuitry 46 may be configured to control any of the methods and/or processes described herein and/or to cause such methods, and/or processes to be performed, e.g., by customer service node 12. Processor 50 corresponds to one or more processors 50 for performing customer service node 12 functions described herein. The memory 48 is configured to store data, programmatic software code and/or other information described herein. In some embodiments, the software 38 may include instructions that, when executed by the processor 50 and/or processing circuitry 46, causes the processor 50 and/or processing circuitry 46 to perform the processes described herein with respect to management node 14. The customer service node 12 is configured to perform one or more functions described herein such as with respect to, for example, providing customer service functions. In some embodiments, the inner workings of the management node 14 and customer service node 12 may be as shown in FIG. 2 and independently, the surrounding network topology may be that of FIG. 1.

Although FIGS. 1 and 2 show the projection and validation unit 22 as being within a respective processor, it is contemplated that these units may be implemented such that a portion of the unit is stored in a corresponding memory within the processing circuitry. In other words, the units may be implemented in hardware or in a combination of hardware and software within the processing circuitry.

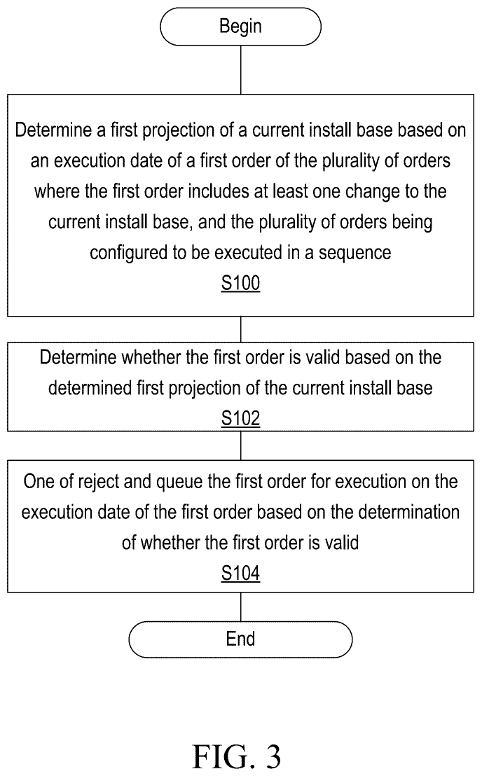

FIG. 3 is a flowchart of an example process in a management node 14 according to one or more embodiments of the present disclosure. One or more blocks described herein may be performed by one or more elements of management node 14 such as by one or more of processing circuitry 32 (including the projection and validation unit 22), processor 36, and/or communication interface 30. Management node 14 is configured to determine (Block S100) a first projection of a current install base based on an execution date of a first order of the plurality of orders where the first order includes at least one change to the current install base, and where the plurality of orders are configured to be executed in a sequence. Management node 14 is further configured to determine (Block S102) whether the first order is valid based on the determined first projection of the current install base. Management node 14 is further configured to one of reject and queue (Block S104) the first order for execution on the execution date of the first order based on the determination of whether the first order is valid.

In at least one embodiment, the processing circuitry 32 is further configured to determine a second projection of the current install base based on an execution date of a second order of the plurality of orders where the second order includes at least one change to the current install base. In at least one embodiment, the second order precedes the first order in the sequence, and the determination of whether the first order is valid is further based on the determined second projection of the current install base. In at least one embodiment, the second order follows the first order in the sequence, and the determination of whether the second order is valid is further based on the determined first projection of the current install base. In at least one embodiment, the sequence is chronological based on execution date of each of the plurality of orders.

In at least one embodiment, the processing circuitry 32 is further configured to determine a projection for each of the plurality of orders, each of the projections for each of the plurality of orders including at least one change to the current install base. In at least one embodiment, determining whether the first order is valid is further based on the determined projections of each of the plurality of orders. In at least one embodiment, determining whether the first order is valid is further based on an evaluation of each of the determined projections of each of the plurality of orders where the evaluation is based on the sequence of execution of the plurality of orders.

Having described the general process flow of arrangements of the disclosure and having provided examples of hardware and software arrangements for implementing the processes and functions of the disclosure, the sections below provide details and examples of arrangements for telecommunications ordering management system.

Some embodiments provide telecommunications ordering management system. One or more management node 14 functions described herein may be performed by one or more of processing circuitry 32, processor 36, projection and validation unit 22, etc. One or more customer service node 12 functions described herein may be performed by one or more of processing circuitry 46, processor 50, etc.

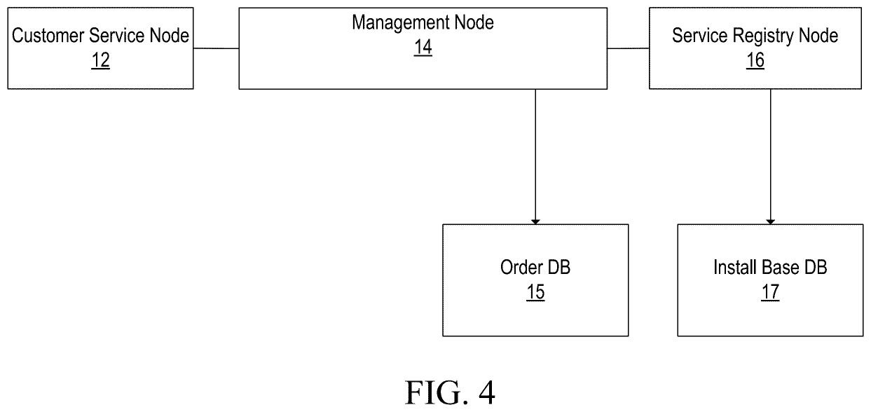

FIG. 4 is a schematic diagram of another example of a network architecture illustrating a communication system according to principles disclosed herein. In FIG. 4, the customer service node 12 is configured to communicate with management node 14. The customer service node 12 may include a user interface (not shown). The user interface provides one or more functions as described herein, and may expose (e.g., allow access to) a customer's install base, allow for changes to the install base via new orders, and provide for a catalog of available products and services and associated pricing, and allow for personalization of data.

The management node 14 is configured to communicate with the service registry node 16 and an order database 15. The management node 14 acts as a layer between the user interface of the customer service node 12 and the order management engine (i.e., part of management node 14) for various functions as described herein, including the creation, management, validation, pricing, and triggering execution of orders. The order management engine may be responsible for reading/creating/and updating order entities. The order management engine provides one or more functions as described herein and may support pricing and validation of orders and trigger order execution based on the orders' respective scheduled time, among other factors.

The service registry node 16 is configured to communicate with an install base database 17. The service registry node 16 provides one or more functions as described herein and may manage a customer's install base, read existing install base products and services, publish changes to the install base, and support queries, and/or perform other functions described herein. The queries may have filters that can be used.

One or more embodiments described herein are realized on the concept of stacked orders: A series of orders is issued to execute in a sequence, where each order is based on a calculated projection of the install base at its execution time instead of the most recent install base snapshot from the persistence layer. The series of orders may be referred to as “stack” and each order has a strict position in the stack based on its scheduled execution time.

When forming a projection:
1) The projection of install base for each order is calculated based on changes anticipated from previous orders in the stack; and/or
2) The projection of install base also considers scheduled lifecycle changes of install base products, e.g. product is expected to expire or activate at certain time point.

Note: The first order in stack relies on the install base loaded from persistence layer. A single order can be viewed as a stack of one order. If the order is not executing immediately but in future, then (2) (projection based on lifecycle changes) may still be considered. In one or more embodiments, a stack may be associated with a customer or subscriber.

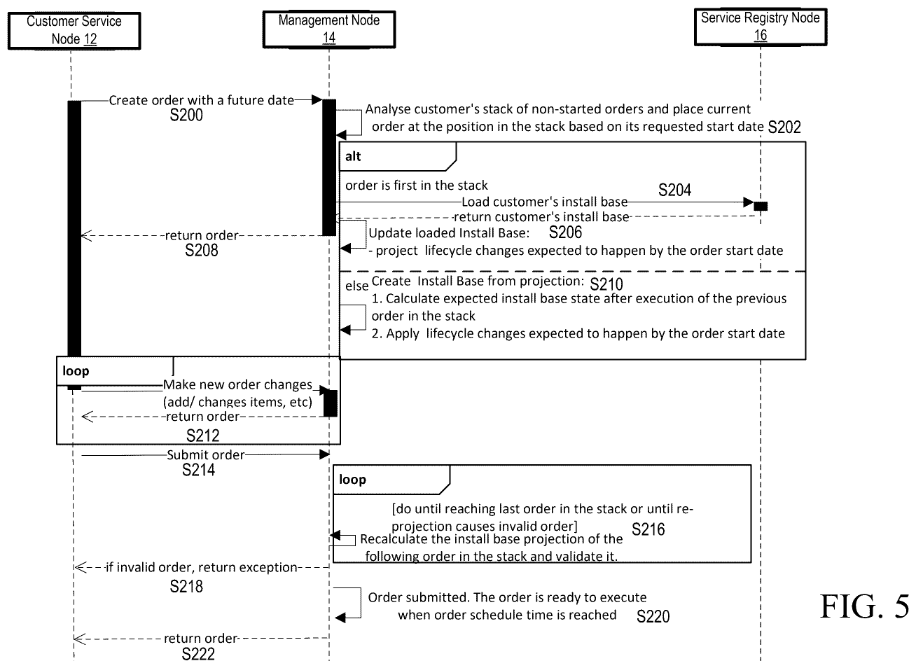

FIG. 5 is an example signaling diagram according to some embodiments of the present disclosure. Customer service node 12 creates an order (e.g., current order) with a future date and sends the order to management node 14 (S200). Management node 14 analyzes the customer's stack of non-started orders and places the current order at the position in the stack based on its requested start date (e.g., execution date) (S202). In one or more embodiments, if the order is the first in the stack, management node 14 request the customer's install base for loading and receives the customer's install base returned from the service registry node 16 (S204). Management node 14 updates the loaded install base by, for example, projecting lifecycle changes expected to happen by the order start date (S206).

In one or more other embodiments, management node 14 creates the install base from the projection at least in part by 1) calculating the expected install base state after execution of the previous order in the stack, and 2) applying lifecycle changes expected to happen by the order start date. Customer service node 12 may make new order changes (e.g., add/change items, etc.) and indicate these changes to management node 14 where management node 14 returns the order to customer service node 12 (S212). In one or more embodiments, S212 may be performed in a logical loop. Customer service node 12 submits order to management node 14 (S214).

Management node 14 recalculates the install base projection of the following order in the stack and validates it, as described herein (S216). In one or more embodiments, S216 is performed in a logical loop until reaching the last order in the stack or until re-projection causes an invalid order. Customer service node 12 returns an exception to management node 14 is the order is invalid (S218). Management node 14 submits the order such that the order is ready to execute when the order's schedule time is reached (S220). Management node 14 returns the order to the customer service node 12 (S222).

An example associated with FIG. 5 is now described. When a new order is issued (S200), the management node then analyzes the customer's stack of un-executed orders and places the current order in a position in the stack based on its start date, i.e. execution date. There are then two scenarios to analyze (S202):
This is the first uncompleted customer order, and will become the first order in the stack. The management node 14 loads the customer's install base by communicating with the service registry node 16. The management node 14 creates a stack with a single order (S204). The order install base comes from a persisted install base. If the order is dated in the future, the management node 14 projects the install base based on possible products/services lifecycle changes (S206).
The customer already has non-completed orders in the stack. The management node inserts the new order in the stack based on the order's requested start date/execution date and returns the order (S208).
   If it's not the first order in the stack, then new order's install base should come from projection assuming previous order executes successfully plus estimated lifecycle changes (S210).
   If there are other orders following the new order, they should be reprojected based on the new order changes (S216). If reprojection detects conflict, then the entire stack of orders should be invalidated before it provisions an invalid service configuration.

The customer service node 12 and management node 14 communicate to make new order changes, such as adding or changing items (S212). If necessary, this may be performed multiple times in a loop (i.e., logical loop) until the changes are made. The order is then submitted by the customer service node 12 to the management node 14 (S214).

The management node 14 then recalculates the install base projection of each successive order in the stack and validates it (S216).

One or more embodiments described herein helps ensure that future-dated orders and stacks of orders run with the best approximation (e.g., most accurate approximation) of the install base at their execution time. And, if there are inconsistencies or conflicts between orders or with the persisted install base, they are detected early at order creation time and can be addressed before the inconsistent changes are provisioned and cause irrevocable behavior by returning an exception in the case of an invalid order (S218). If there are no inconsistencies, the order is submitted and ready to execute when the order schedule time/execution time occurs (S220) and returned (S222).

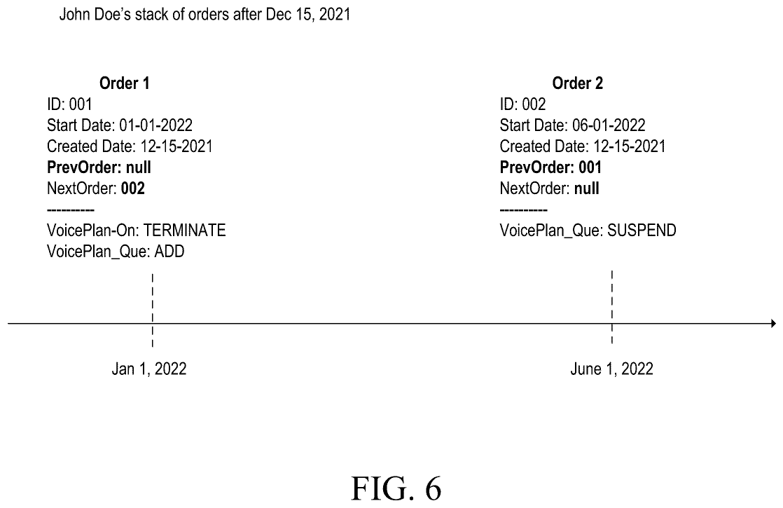

The following example(s) describes how one or more embodiments described herein can be used in certain scenarios illustrated in FIGS. 6-8.

John Doe is going to temporary relocate from Toronto, Ontario to Montreal, Quebec to complete his graduate studies and he wishes to setup his mobile phone arrangements in advance. On Dec. 15, 2021 John Doe calls his mobile operator and requests to terminate his current Ontario plan and activate a new Quebec voice plan as of Jan. 1, 2022. He also requests to suspend his new Quebec voice plan on Jun. 1, 2022 as he will be travelling abroad in the upcoming summer.

The operator takes the requests and creates 2 future-dated orders. The Order1 is created to terminate Ontario voice plan and to activate new Quebec voice plan and is scheduled to run on Jan. 1, 2022. The Order2 suspends Quebec voice plan and is scheduled to run on Jun. 1, 2022. This situation is illustrated in FIG. 6 that is a timeline diagram of execution dates of Order 1 and Order 2. FIG. 6 depicts John Doe's stack of orders after Dec. 15, 2021, according to the foregoing example. Order 1 has an ID of 001, a start date of Jan. 1, 2022, a created date of Dec. 15, 2021, does not refer to a previous order (i.e., the PrevOrder field is null), and points to order ID 002 as the next order. It terminates the Ontario voice plan and activates the Quebec voice plan. Order 2 has an ID of 002, start date of Jun. 1, 2022, a created date of Dec. 15, 2021, refers to order ID 001 as the previous order, and does not refer to a next order (i.e., the NextOrder field is null). It suspends the Quebec voice plan.

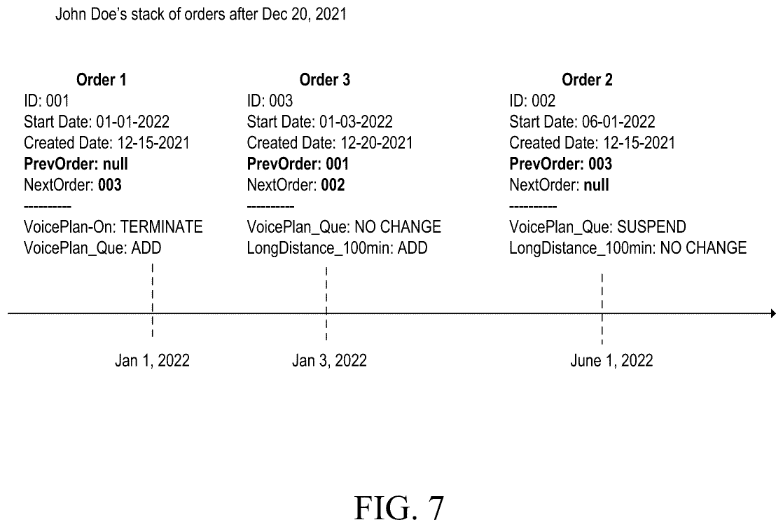

Few days later, on Dec. 20, 2022, John Doe calls the operator again and asks for an add-on product “100 long-distance minutes for 10$” to be added to his subscription as of Jan. 3, 2022. The operator creates Order 3 scheduled for Jan. 3, 2022 and adds the add-on on top of the Quebec voice plan as illustrated in FIG. 7 that is a timeline diagram of execution dates of Order 1, Order 2 and Order 3 described above according to one or more embodiments of the present disclosure. In particular, FIG. 7 depicts John Doe's stack of orders after Dec. 20, 2021, according to the foregoing example. Order 3 has been inserted between Orders 1 and 2. Order 3 has an ID of 003, start date of Jan. 3, 2022, a created date of Dec. 20, 2021, refers to order ID 001 as the previous order and order ID 002 as the next order. Order 1 has been changed to point to 003 as the next order, and Order 2 has been changed to point to 003 as the previous order.

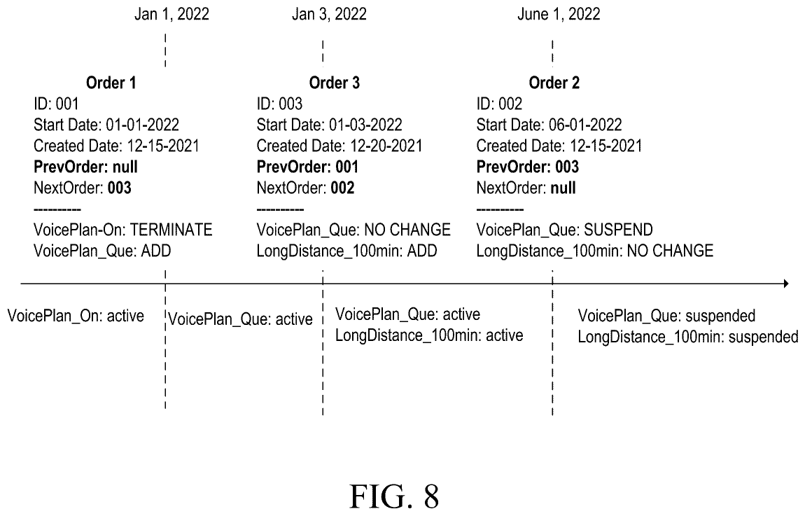

FIG. 8 is a timeline diagram of a customer's install base according to one or more embodiments of the present disclosure. FIG. 8 depicts the status of John Doe's services, e.g., his voice plan and long-distance minutes, according to the foregoing example.

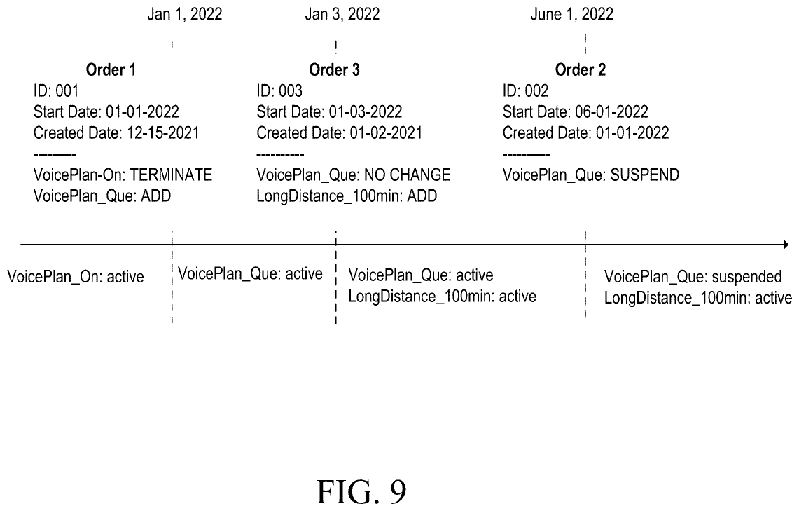

FIG. 9 is a diagram of the foregoing example scenario that was handled without using one or more of the embodiments described herein. It depicts the status of John Doe's services, e.g. his voice plan and long-distance minutes. Since the orders are not projected according to functions described herein, they do not have PrevOrder or NextOrder fields.

First of all, the mobile operator is not able to place two consecutive future dated orders Order 1 and Order 2. A customer service representative will place Order1, but not Order 2 because the new voice plan is not in the install base, so there is nothing for Order 2 to suspend. John Doe would need to call back after Jan. 1, 2022, once Quebec voice plan is active and, in the install base, issue a suspend request again. This suspend request may become challenging to achieve once customer's request is a series of multiple complex orders executing right after another without delays.

The add-on “Long Distance 100 min” again will need to be added after Jan. 1, 2022 for the same reason. Let's assume on Jan. 2, 2022 John Doe calls in and places “Suspend” order scheduled for Jun. 1, 2022. Later that day John Doe realizes he may take advantage of the “Long Distance 100 min” and calls again to place Order 3 (Add-On) to execute on Jan. 3, 2022, that is before “Suspend” order. The Add-On Order 3 runs successfully adding needed long-distance minutes to the customer's subscription on a monthly basis.

There are no problems until Jun. 1, 2022 is reached when it's time to run the scheduled Suspend order. Typically, “Add-On” lifecycle aligns with the main plan lifecycle because add-on is using same services as the main plan. When a plan is suspended or deactivated, so are all connected add-ons. Going back to the example of FIG. 9, the Suspend order is not aware of the “Add-On” added to the voice plan after Suspend order was created. Therefore, when Order 3 runs it only suspends the voice plan yet leaving the Add-On product active. Depending on mobile operator handling, it may cause variety of scenarios from subscription issues to unwanted charges for a product that cannot be serviced. There are thus several shortcomings of an approach that does not use one or more of the embodiments described herein.

Though the above-described example is of low complexity, it should be appreciated that in more complex use cases similar issues arise, leading to orders that either cannot be fulfilled or are fulfilled with unexpected or unintended results where one or more embodiments of the present disclosure are able to determine these invalid orders before these orders are implemented.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A management node for managing a plurality of orders, the management node comprising:
processing circuitry configured to:
determine a first projection of a current install base based on an execution date of a first order of the plurality of orders, the first order including at least one change to the current install base, and the plurality of orders being configured to be executed in a sequence;
determine whether the first order is valid based on the determined first projection of the current install base; and
one of reject and queue the first order for execution on the execution date of the first order based on the determination of whether the first order is valid.

2. The management node of claim 1, wherein the processing circuitry is further configured to determine a second projection of the current install base based on an execution date of a second order of the plurality of orders, the second order includes at least one change to the current install base.

3. The management node of claim 2, wherein the second order precedes the first order in the sequence, and the determination of whether the first order is valid is further based on the determined second projection of the current install base.

4. The management node of claim 2, wherein the second order follows the first order in the sequence, and the determination of whether the second order is valid is further based on the determined first projection of the current install base.

5. The management node of claim 1, wherein the sequence is chronological based on execution date of each of the plurality of orders.

6. The management node of claim 1, wherein the processing circuitry is further configured to determine a projection for each of the plurality of orders, each of the projections for each of the plurality of orders including at least one change to the current install base.

7. The management node of claim 6, wherein determining whether the first order is valid is further based on the determined projections of each of the plurality of orders.

8. The management node of claim 7, wherein determining whether the first order is valid is further based on an evaluation of each of the determined projections of each of the plurality of orders, the evaluation being based on the sequence of execution of the plurality of orders.

9. A method implemented by a management node for managing a plurality of orders, the method comprising:
determining a first projection of a current install base based on an execution date of a first order of the plurality of orders, the first order including at least one change to the current install base, and the plurality of orders being configured to be executed in a sequence;
determining whether the first order is valid based on the determined first projection of the current install base; and
one of rejecting and queuing the first order for execution on the execution date of the first order based on the determination of whether the first order is valid.

10. The method of claim 9, further comprising determining a second projection of the current install base based on an execution date of a second order of the plurality of orders, the second order includes at least one change to the current install base.

11. The method of claim 10, wherein the second order precedes the first order in the sequence, and the determination of whether the first order is valid is further based on the determined second projection of the current install base.

12. The method of claim 10, wherein the second order follows the first order in the sequence, and the determination of whether the second order is valid is further based on the determined first projection of the current install base.

13. The method of claim 9, wherein the sequence is chronological based on execution date of each of the plurality of orders.

14. The method of claim 9, further comprising determining a projection for each of the plurality of orders, each of the projections for each of the plurality of orders including at least one change to the current install base.

15. The method of claim 14, wherein determining whether the first order is valid is further based on the determined projections of each of the plurality of orders.

16. The method of claim 15, wherein determining whether the first order is valid is further based on an evaluation of each of the determined projections of each of the plurality of orders, the evaluation being based on the sequence of execution of the plurality of orders.

17. A non-transitory computer readable medium storing an executable program comprising instructions that when executed by a processor are configured to cause processing circuitry to:
determine a first projection of a current install base based on an execution date of a first order of the plurality of orders, the first order including at least one change to the current install base, and the plurality of orders being configured to be executed in a sequence;
determine whether the first order is valid based on the determined first projection of the current install base; and
one of reject and queue the first order for execution on the execution date of the first order based on the determination of whether the first order is valid.

18. The computer readable medium of claim 17, wherein the instructions are further configured to cause the processing circuitry to determine a second projection of the current install base based on an execution date of a second order of the plurality of orders, the second order includes at least one change to the current install base.

19. The computer readable medium of claim 18, wherein the second order precedes the first order in the sequence, and the determination of whether the first order is valid is further based on the determined second projection of the current install base.

20. The computer readable medium of claim 18, wherein the second order follows the first order in the sequence, and the determination of whether the second order is valid is further based on the determined first projection of the current install base.
